(19) United States
(12) Patent Application Publication
(10) Pub. No.: US 2025/0315312 A1
(43) Pub. Date: Oct. 9, 2025

(54) Managing Different Compute-Intensive Workloads In Cloud

(71) Applicant: International Business Machines Corporation, Armonk, NY (US)

(72) Inventors: Tareq Al-Maamari, Böblingen (DE); Enrico Regge, Stuttgart (DE); Sugandha Agrawal, Holzgerlingen (DE); Peter Gerstl, Holzgerlingen (DE); Simon Daniel Moser, Gärtringen (DE); Michael Beck, Bad Teinach-Zavelstein (DE)

(21) Appl. No.: 18/630,416

(22) Filed: Apr. 9, 2024

(51) Int. Cl. G06F 9/50; G06F 11/07; G06F 11/34

(52) U.S. Cl. CPC G06F 9/505; G06F 9/5044; G06F 11/0772; G06F 11/3433

(57) ABSTRACT

Enhancing data processing is provided. A plurality of derivative application instances is generated to run a plurality of parallel jobs based on an image of an instance of an application providing a service corresponding to a data processing request. One derivative application instance is generated for each respective job of the plurality of parallel jobs to run the plurality of parallel jobs to meet defined data processing performance objectives. The plurality of parallel jobs is run on the plurality of derivative application instances at the same time in parallel to increase data processing throughput and decrease an amount of time and resources needed to fulfill the data processing request. Each job of the plurality of parallel jobs retrieves a particular chunk of a dataset corresponding to the data processing request from a database to process that particular chunk of the dataset to generate a sub-result of the data processing request.

### BACKGROUND

The disclosure relates generally to data processing and more specifically to enhancing data processing performance.

Data processing is the collection, manipulation, and retrieval of digital data to produce usable and meaningful information. Data processing is a form of information processing, which is the modification of the information in a manner requested by a user. Once processed, this information can be used for a variety of different purposes. Typically, data processing involves a large amount of input data and a large amount of output data. For example, an insurance company needs to keep records on tens or hundreds of thousands of policies, print and mail bills, and receive and post payments.

### SUMMARY

According to one illustrative embodiment, a computer-implemented method for enhancing data processing is provided. A computer generates a plurality of derivative application instances to run a plurality of parallel jobs based on an image of an instance of an application providing a service corresponding to a data processing request. The computer generates one derivative application instance for each respective job of the plurality of parallel jobs to run the plurality of parallel jobs at a same time in parallel to meet defined data processing performance objectives. The computer runs the plurality of parallel jobs on the plurality of derivative application instances at the same time in parallel to increase data processing throughput and decrease an amount of time and resources needed to fulfill the data processing request. Each job of the plurality of parallel jobs retrieves a particular chunk of a dataset corresponding to the data processing request from a database to process that particular chunk of the dataset to generate a sub-result of the data processing request. According to other illustrative embodiments, a computer system and computer program product for enhancing data processing are provided.

### BRIEF DESCRIPTION OF THE DRAWINGS

FIG. 1 is a pictorial representation of a computing environment in which illustrative embodiments may be implemented;

FIG. 2 is a diagram illustrating an example of a data processing enhancement system in accordance with an illustrative embodiment;

FIG. 3 is a diagram illustrating an example of a data processing enhancement process in accordance with an illustrative embodiment; and

FIGS. 4A-4C are a flowchart illustrating a process for enhancing data processing in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

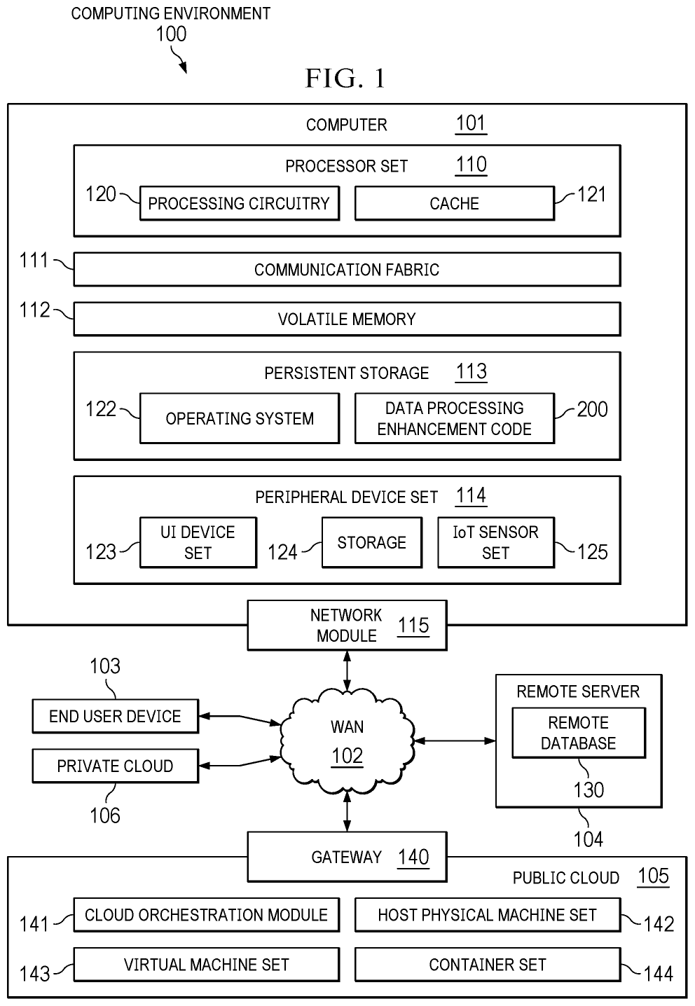

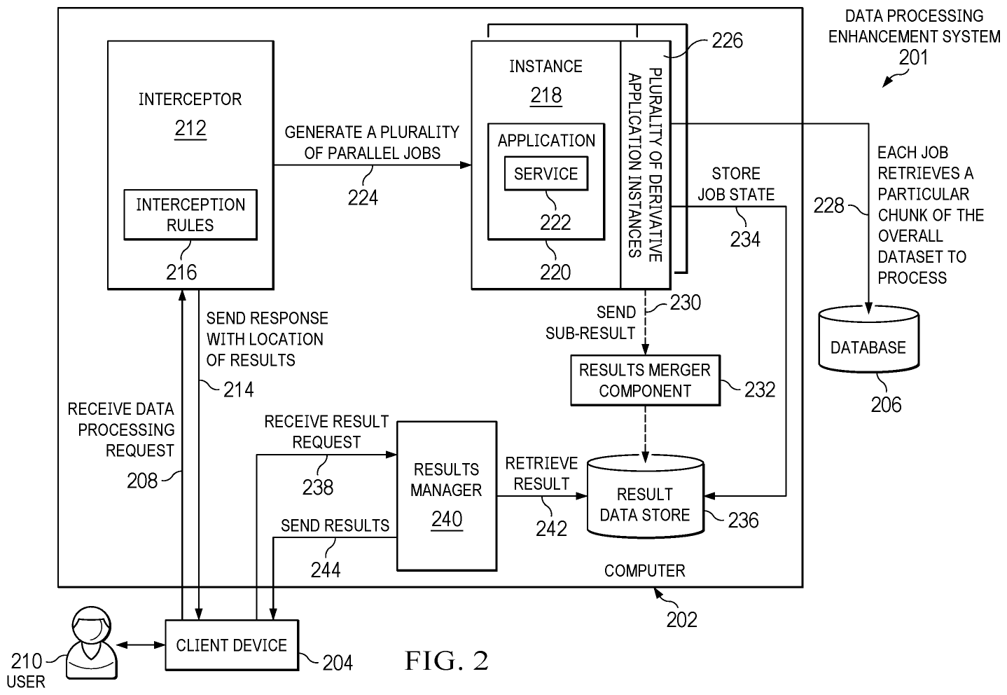

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as data processing enhancement code 200.

For example, an entity (e.g., “entity Y”), which corresponds to an application that provides a service, defines and provides a plurality of interception rules for processing certain data processing requests. The entity may be, for example, an enterprise, business, company, organization, institution, agency, or the like. Data processing enhancement code 200 implements an interceptor of illustrative embodiments that includes the entity-defined plurality of interception rules. The interceptor utilizes the interception rules to intercept any data processing request that satisfies one of the interception rules, such as, for example, GET/v1/salaries?entity=Y, to an instance of the application providing the service. The interceptor generates a plurality of parallel jobs corresponding to the data processing request based on the entity-defined parameters in the corresponding interception rule. The entity-defined parameters of an interception rule include, for example, identifier of the entity corresponding to the data processing request, identifier of the application providing the service, identifier of the database providing the dataset corresponding to the data processing request, type of data in the dataset, size of the dataset, timeframe to complete the data processing job, number of resources needed to complete the data processing job, and the like.

Data processing enhancement code 200 dynamically scales the application into a plurality of sub-applications based on the entity-defined parameters of the interceptor rule corresponding to each respective incoming data processing request associated with the application. Each job of the plurality of parallel jobs retrieves a particular chunk, segment, part, or portion of the entire dataset associated with the data processing request and processes that particular chunk of the dataset separately from the other jobs in the plurality of parallel jobs. Once each respective job completes processing its particular chunk of the dataset associated with the data processing request, data processing enhancement code 200 utilizes a results merger component of illustrative embodiments to merge all of the processed chunks of the input dataset into a single data processing result when needed. The entity which provides the interception rules, also provides the merge logic or code for merging all of the different processed chunks of the dataset.

Thus, data processing enhancement code 200 improves performance of the application by dividing the application's to-be-processed input dataset associated with the data processing request into a plurality of data chunks in accordance with the interception rule corresponding to the data processing request. Data processing enhancement code 200 utilizes an instantiated derivative application instance (e.g., a sidecar container) of the original instance corresponding to the application to run one job of the plurality of parallel jobs to process one particular chunk of the dataset in parallel with the other jobs of the plurality of parallel jobs, which are running on other instantiated derivative application instances, that are processing the other chunks of the dataset associated with the data processing request. In other words, data processing enhancement code 200 utilizes a plurality of instances of the same application instance to improve system performance when processing a large dataset. Data processing enhancement code 200 utilizes an instantiated derivative application instance, which manipulates content of the data processing request and the associated response, to intercept and modify the data processing request to retrieve a particular chunk of the dataset from a downstream dependency (e.g., database, microservice, storage device, or the like) in accordance with the interception rule corresponding to the data processing request.

Thus, data processing enhancement code 200 is capable of managing different compute-intensive data-driven workloads of microservices corresponding to applications without having to refactor the microservices to handle different workload variants. As a result, data processing enhancement code 200 improves the data processing throughput of microservice-based applications in distributed data processing systems, such as, for example, cloud environments.

In addition to data processing enhancement code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data processing enhancement code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in data processing enhancement code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a user of an entity that is utilizing the enhanced data processing services provided by computer 101), and may take any of the forms discussed above in connection with computer 101. EUD 103 typically receives helpful and useful data from the operations of computer 101. For example, in a hypothetical case where computer 101 is designed to provide a data processing result to the end user, this data processing result would typically be communicated from network module 115 of computer 101 through WAN 102 to EUD 103. In this way, EUD 103 can display, or otherwise present, the data processing result to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a data processing result based on a historical dataset, then this historical dataset may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Illustrative embodiments increase the data processing throughput of microservice-based applications in distributed data processing systems, such as, for example, cloud environments. For example, illustrative embodiments manage different compute-intensive data-driven workloads of a microservice-based application without the need to refactor the microservice-based application to handle different workload variants. Illustrative embodiments utilize an interceptor to intercept and analyze all incoming data processing requests and determine whether to allow the microservice-based application instance to process a particular data processing request as is or to divide that particular data processing request into a plurality of sub-requests when the dataset corresponding to that particular data processing request is large (e.g., greater than an entity-defined maximum dataset size threshold level set in the corresponding interception rule for that particular data processing request) or when processing of the dataset is complex (e.g., processing of the dataset needs more time and/or resources than an entity-defined maximum time threshold level and maximum resources threshold level set in the corresponding interception rule). Then, the interceptor of illustrative embodiments generates a plurality of parallel jobs (e.g., a batch job) corresponding to the plurality of sub-requests. In other words, the interceptor generates one job of the plurality of jobs to process one sub-request of the plurality of sub-requests.

In cloud environments, especially with scale-to-zero microservice-based applications, distributed workloads can be scaled down to zero when resources are no longer needed and can also be scaled up in a matter of milliseconds when needed. This scalability enables microservice-based applications to handle different workloads variants. However, even with this microservice scalability, a computing resources limit per microservice still exists that currently makes it difficult for one microservice to process large amounts of data. Parallel data processing (e.g., batch job) in a cloud environment overcomes that challenge by exploiting the power of the cloud environment to achieve high performance computing, and thus, enables the cloud environment to run parallel jobs in an efficient manner.

However, a microservice may need to handle different amounts of input data when processing a large dataset, even with the advantages that a cloud environment can provide. For example, the microservice is not capable of unlimitedly scaling up computing resources that are needed by the microservice to process such a large amount of data. Thus, restrictions on how much input data a microservice can handle exists. Such a scenario is common especially in data-driven microservice-based applications.

Illustrative embodiments enable current cloud environments to manage different amounts of input data by intercepting incoming data processing requests and generating a plurality of parallel jobs to process the large amount of data using the same application codebase without any code modification. Thus, illustrative embodiments extend cloud environments to handle different input data amounts needed to be processed by a hosted microservice-based application. This allows application developers to focus on the application code without concern for handling the different amounts of input data or workload variants.

Typically, any new incoming data processing request is sent to a deployed application instance for processing. In this example, to process that specific data processing request, the application instance needs to retrieve and process a large amount of data from a backend database or storage unit, or the processing of the data is complex (e.g., the application instance needs more computing resources to process the data than are allocated to the application instance). In other words, in this example, the application instance is not capable of sufficiently scaling up to process the data associated with that particular data processing request.

Illustrative embodiments learn the parameters (e.g., features, characteristics, attributes, context, conditions, or the like) associated with that particular data processing request and generate an interception rule for any similar future incoming data processing requests. The interception rule includes, for example, a set of parameters, an identifier of an endpoint where the data processing request is to be sent for processing, and an identifier of the database containing the dataset corresponding to the data processing request. The entity corresponding to the data processing request defines the set of parameters in the interception rule. The endpoint is the application instance where the data processing associated with the data processing request is to be performed. The “learning” by illustrative embodiments can occur in one of two ways. One way is for the application owner (i.e., the entity) to generate a plurality of different interception rules that direct the interceptor of illustrative embodiments to intercept certain data processing requests. Another way is for illustrative embodiments to utilize an auto-detection mechanism (e.g., a trained machine learning model) to detect and generate interception rules to cover more scenarios for intercepting certain data processing requests.

For any similar future data processing requests, the interceptor, utilizing the interception rules, will not forward a particular data processing request, which satisfies a particular interception rule, to the application instance for processing. Instead, the interceptor of illustrative embodiments sends a response to the client device, which sent the data processing request, indicating that the particular data processing request is accepted and informing the user of the client device where a result of the data processing will be located for retrieval. The response may be, for example, a 202 HTTP status code (i.e., acceptance). The location for the retrieval of the data processing result may be, for example, a REST API endpoint.

After sending the response to the client device, the interceptor generates a plurality of parallel jobs in accordance with the entity-defined parameters of the interception rule corresponding to that particular data processing request. Each respective job of the plurality of parallel jobs runs on a corresponding derivative application instance (e.g., a sidecar container) of the original application instance, which intercepts the data retrieval request (e.g., a select statement directed towards a backend database or storage unit containing the input dataset) and modifies the data retrieval request to retrieve only a particular chunk of the input dataset. In other words, a different subset of the input dataset corresponding to the data processing request is retrieved by each different job of the plurality of parallel jobs.

The interceptor of illustrative embodiments generates each respective derivative instance using the same codebase and image corresponding to the application providing the service. Each respective derivative application instance retrieves only one particular chunk of the entire dataset associated with that particular data processing request so that a particular job of the plurality of parallel jobs running on a given derivative application instance only processes a portion of the entire input dataset. By utilizing a plurality of derivative application instances to run the plurality of parallel jobs to process the plurality of different chunks of the dataset in parallel, illustrative embodiments decrease the time needed to obtain the data processing result, which increases system performance by decreasing the time and resources needed to generate the final data processing result.

It should be noted that the number of the plurality of parallel jobs needed to process the input dataset depends on the amount of data retrieved from the database to fulfill or satisfy the data processing request. For example, the interceptor divides the incoming data processing request into a plurality of sub-requests in accordance with the interception rule corresponding to the incoming data processing request. Thus, each respective job of the number of the plurality of parallel jobs receives a sub-request with a modified data retrieval request to retrieve only a particular chunk of the dataset from the database in accordance with the entity-defined set of parameters in the interception rule corresponding to the original incoming data processing request. As a result, each respective derivative application instance of the plurality of derivative application instances running the plurality of parallel jobs intercepts the data retrieval request and modifies the data retrieval request so that the modified data retrieval request only retrieves one particular chunk of the input dataset corresponding to that particular job running in that particular derivative application instance for processing.

The user of the client device, which sent the data processing request, can access the data processing result via a results manager of illustrative embodiments. Optionally, after each job completes processing its particular chunk of the input dataset, a results merger component of illustrative embodiments can merge the output of each job into a single data processing result. The entity corresponding to the data processing request defines when and how the results merger component merges the outputs of the plurality of parallel jobs. The results merger component stores the merged data processing result in a result data store managed by the entity for retrieval by the user of the client device.

Illustrative embodiments utilize a machine learning model to learn different database query patterns over time. For example, a correlation exists between an incoming data processing request and a query that the application needs to perform against the backend database to retrieve the input data needed to generate a result corresponding to the data processing request. In order to be able to determine when to generate the plurality of parallel jobs corresponding to the data processing request and which input dataset to retrieve from which backend database, illustrative embodiments employ one of two methods. One method is for the entity, which owns the application providing the service, to define in an interception rule, as part of the deployment configuration, the parameters and characteristics of a particular incoming data processing request and identification of the backend database where the application is to perform a query to retrieve the input dataset corresponding to that particular incoming data processing request. The other method is for illustrative embodiments to utilize causal inference, reinforcement learning, and other machine learning techniques to automatically detect and generate new interception rules. The interceptor of illustrative embodiments then utilizes the interception rules to determine when to generate a plurality of parallel jobs corresponding to a particular incoming data processing request and which input dataset to retrieve from which backend database to feed into the plurality of parallel jobs running on a plurality of derivative application instances.

As an illustrative example use case, an application provides a service that is responsible for processing salaries of an entity. This salary processing service works well for processing salaries up to a certain number of salaries. However, situations exist when the salary processing service is unable to process all salaries of an entity. For example, the salary processing service is unable to process all salaries of an entity when the number of salaries to process is large or when the processing of the salaries is complex (e.g., the resources allocated to the salary processing service are insufficient to handle the workload). Even though such situations exist, it does not make sense to refactor the application codebase to resolve such situations. Illustrative embodiments are capable of handling such situations without needing to refactor the application codebase.

An example salary processing request can be to process all salaries of entity X, where entity X has 1,000 workers. This example salary processing request for entity X can be processed normally without any complex processing. However, processing all salaries of entity Y, where entity Y has 100,000 workers, is more complex needing more computing resources than allocated to the application instance that is to process the request. The application owner previously provided an interception rule that corresponds to salary processing requests of entity Y. Therefore, the interceptor of illustrative embodiments intercepts all incoming salary processing requests of entity Y that satisfy the interception rule ‘GET/v1/salaries?entity=Y’. After intercepting such a salary processing request, the interceptor then generates a plurality of parallel jobs corresponding to the salary processing request. Each respective job of the plurality of parallel jobs retrieves a particular chunk of the input dataset from the backend database and processes that particular chunk of the input dataset separately. After each respective job of the plurality of parallel jobs completes processing its particular chunk of the input dataset, a results merger component of illustrative embodiments merges all of salary processing results generated by the plurality of parallel jobs into a single salary processing result for entity Y. The application owner provides the merge logic.

Another illustrative example use case is for stock market predictions. Currently, many simulations and algorithms exist where an enormous number of trials with different random numbers generated from an underlying distribution for uncertain variables are used. A large set of historic data is fed into the stock market prediction service, which is mainly a script using libraries. The script using the libraries processes the large set of historic data being fed into the service.

An example stock market prediction request can be to process the value of a stock over a user-defined period (e.g., 20 years) and predict the value of the stock in the future using a Monte Carlo Simulation. As the user requests to process the value of the stock over longer periods of time, running these predictions can become very complex. Thus, distributing the predictions to a plurality of parallel jobs would be helpful.

The application owner previously provided an interception rule to process requests for any given period of years (e.g., Z number of years). Therefore, the interceptor intercepts all such incoming data processing requests that meet the interception rule ‘GET/v1/stock?years=Z’. The interceptor then generates a plurality of parallel jobs to handle the data processing request for predicting the value of the stock over Z number of years. Each job retrieves only a particular chunk of the historic stock value data (e.g., 3 months, 6 months, 1 year, or the like of a particular chunk of the historical value of the stock within the Z number of years) from the backend database and processes only that particular chunk of the historic stock value data separately from the other jobs of the plurality of parallel jobs. This in turn calculates drifts, daily returns, and the like. After the plurality of parallel jobs processes all of the historic stock value data over Z number of years, the results merger component of illustrative embodiments merges the processed data. The application owner provides the merge logic.

Thus, illustrative embodiments provide one or more technical solutions that overcome a technical problem with an inability of current cloud data processing systems to manage different compute-intensive data-driven workloads of microservices corresponding to applications without having to refactor the microservices to handle different workload variants. As a result, these one or more technical solutions provide a technical effect and practical application in the field of data processing.

With reference now to FIG. 2, a diagram illustrating an example of a data processing enhancement system is depicted in accordance with an illustrative embodiment. Data processing enhancement system 201 may be implemented in a computing environment, such as computing environment 100 in FIG. 1. Data processing enhancement system 201 is a system of hardware and software components for increasing data processing throughput using a plurality of parallel jobs running on a plurality of derivative application instances to fulfill a data processing request, thereby decreasing time and resources needed to obtain a data processing result.

In this example, data processing enhancement system 201 includes computer 202, client device 204, and database 206. Computer 202, client device 204, and database 206 can be, for example, computer 101, EUD 103, and remote database 130. However, it should be noted that data processing enhancement system 201 is intended to be an example only and not a limitation on illustrative embodiments. For example, data processing enhancement system 201 can include any number of computers, client devices, remote databases, and other devices and components not shown.

At 208, computer 202 receives a data processing request from user 210 via client device 204. The data processing request may be, for example, a hypertext transfer protocol (HTTP) request. User 210 corresponds to an entity. The entity owns the dataset in database 206.

Computer 202 utilizes interceptor 212 to receive and analyze the data processing request. At 214, in response to receiving the data processing request, interceptor 212 sends an acceptance response regarding the data processing request, along with a location in a result data store where the data processing result will be stored for retrieval. The acceptance response may be, for example, a 202 HTTP status code indicating acceptance. In addition, interceptor 212 utilizes interception rules 216 to analyze the data processing request. Interception rules 216 represent a plurality of different interception rules defined and provided by the entity corresponding to user 210 or generated automatically over time by a trained machine learning model of the interceptor.

If interceptor 212 determines that the data processing request does not satisfy or match one of interception rules 216 after analyzing the data processing request, then interceptor 212 transfers the data processing request to instance 218 of application 220 to process. Application 220 provides service 222. Service 222 can represent any type of data processing service provided to subscribing entities.

If interceptor 212 determines that the data processing request does satisfy or match one of interception rules 216 after analyzing the data processing request, then, at 224, interceptor 212 generates a plurality of parallel jobs corresponding to the data processing request in accordance with the defined parameters of the matching interception rule. Further, interceptor 212 generates plurality of derivative application instances 226, one derivative application instance for each respective job of the plurality of parallel jobs. Interceptor 212 generates plurality of derivative application instances 226 using the image corresponding to instance 218 and the codebase corresponding to application 220. As a result, plurality of derivative application instances 226 has the same functionality and capabilities as application 220 to provide service 222.

Interceptor 212 runs the plurality of parallel jobs on plurality of derivative application instances 226 at the same time in parallel to increase data processing throughput and decrease time and resources needed to generate the data processing result. At 228, each respective job of the plurality of parallel jobs retrieves a particular chunk of the overall dataset corresponding to the data processing request from database 206 to process individually in accordance with the defined parameters of the interception rule matching the data processing request. However, it should be noted that each job requests the entire dataset, but the corresponding derivative application instance of that particular job intercepts the request for the entire dataset and modifies the request so that that particular job only retrieves a particular chunk of the entire dataset in accordance with the interception rule corresponding to the original data processing request.

At 230, each of the plurality of parallel jobs running on plurality of derivative application instances 226 sends its corresponding sub-result to results merger component 232. In addition, at 234, plurality of derivative application instances 226 store the job state of each of the plurality of parallel jobs in result data store 236.

Results merger component 232, using merge logic provided by the entity corresponding to user 210, determines whether to merge all of the sub-results received from the plurality of parallel jobs. If results merger component 232 determines that all of the sub-results received from the plurality of parallel jobs needs to be merged based on the merge logic, then results merger component 232 merges all of the sub-results received from the plurality of parallel jobs into a single data processing result and stores the data processing result in result data store 236. Otherwise, results merger component 232 stores all of the sub-results received from the plurality of parallel jobs in result data store 236.

Subsequently, at 238, computer 202 receives a data processing result request from user 210 via client device 204. Computer 202 utilizes results manager 240 to receive the data processing result request. The data processing result request includes the location within result data store 236 where the data processing result corresponding to the data processing request is stored. It should be noted that interceptor 212 sent the location with the acceptance response at 214.

At 242, in response to receiving the data processing result request, results manager 240 retrieves the data processing result from result data store 236. Then, at 244, results manager 240 sends the data processing result to user 210 via client device 204.

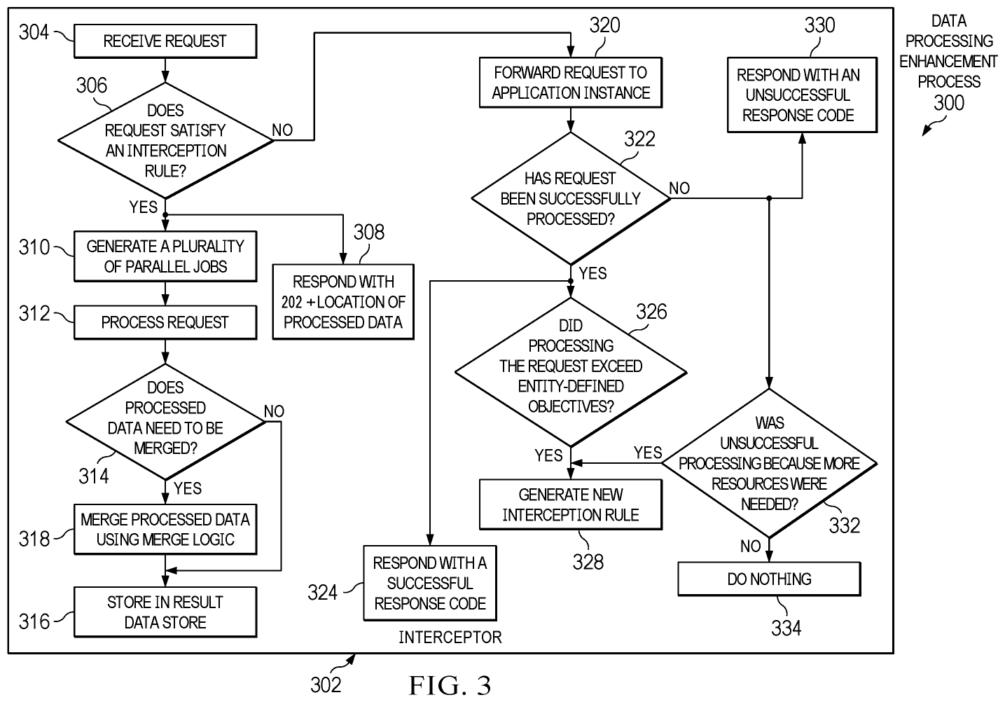

With reference now to FIG. 3, a diagram illustrating an example of a data processing enhancement process is depicted in accordance with an illustrative embodiment. Data processing enhancement process 300 is implemented in interceptor 302. Interceptor 302 can be, for example, interceptor 212 in FIG. 2.

Data processing enhancement process 300 starts at 304 where interceptor 302 receives a data processing request from a client device of a user, such as, for example, client device 204 of user 210 in FIG. 2. At 306, interceptor 302 determines whether the data processing request satisfies or matches an interception rule of a plurality of interception rules. The plurality of interception rules can be, for example, interception rules 216 in FIG. 2.

If interceptor 302 determines that the data processing request does satisfy an interception rule, then, at 308, interceptor 302 responds with a 202 HTTP status code and a location of the processed data (i.e., the data processing result). In addition, at 310, interceptor 302 generates a plurality of parallel jobs. Further, at 312, interceptor 302 processes the data processing request using the plurality of parallel jobs.

Then, at 314, interceptor 302 determines whether the processed data needs to be merged using merge code of a results merger component, such as, for example, results merger component 232 in FIG. 2. If interceptor 302 determines that the processed data does not need to be merged, then, at 316, interceptor 302 stores the processed data in a result data store, such as, for example, result data store 236 in FIG. 2. If interceptor 302 determines that the processed data does need to be merged, then, at 318, interceptor 302 merges the processed data using the merge logic of the results merger component.

If, at 306, interceptor 302 determines that the data processing request does not satisfy an interception rule, then, at 320, interceptor 302 forwards the data processing request to the application instance. The application instance can be, for example, instance 218 of application 220 in FIG. 2.

At 322, interceptor 302 determines whether the data processing request has been successfully processed by the application instance. If interceptor 302 determines that the data processing request has been successfully processed, then, at 324, interceptor 302 responds with a successful response code. In addition, at 326, interceptor 302 determines whether processing the data processing request exceeded entity-defined data processing performance objectives regarding an amount of time and resources needed to fulfill the data processing request. If interceptor 302 determines that the processing of the data processing request did exceed the entity-defined data processing performance objectives, then, at 328, interceptor 302, utilizing a trained machine learning model, generates a new interception rule for any future similar data processing requests such that any future similar data processing request will comply with the entity-defined data processing performance objectives.

If, at 322, interceptor 302 determines that the data processing request has not been successfully processed, then, at 330, interceptor 302 responds with an unsuccessful response code. In addition, at 332, interceptor 302 determines whether the unsuccessful processing of the data processing request was because more resources were needed to process the data processing request than were allocated to the application instance. If interceptor 302 determines that the unsuccessful processing of the data processing request was not because more resources were needed to process the data processing request, then, at 334, interceptor 302 does nothing. If interceptor 302 determines that the unsuccessful processing of the data processing request was because more resources were needed to process the data processing request, then, at 328, interceptor 302 generates a new interception rule regarding the need to allocate more resources for future similar data processing requests in accordance with the entity-defined data processing performance objectives.

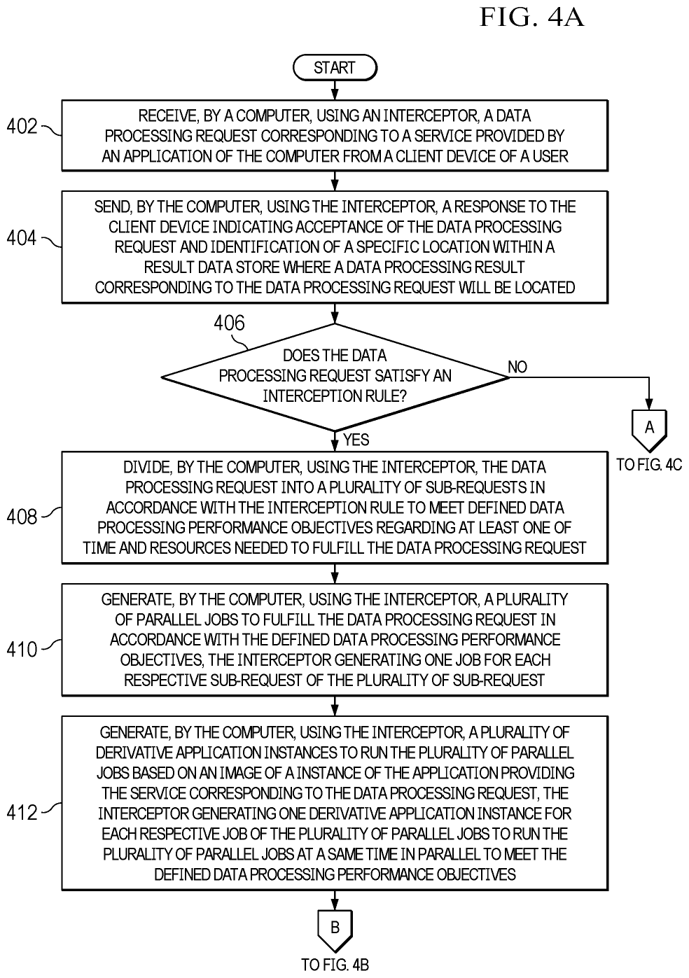

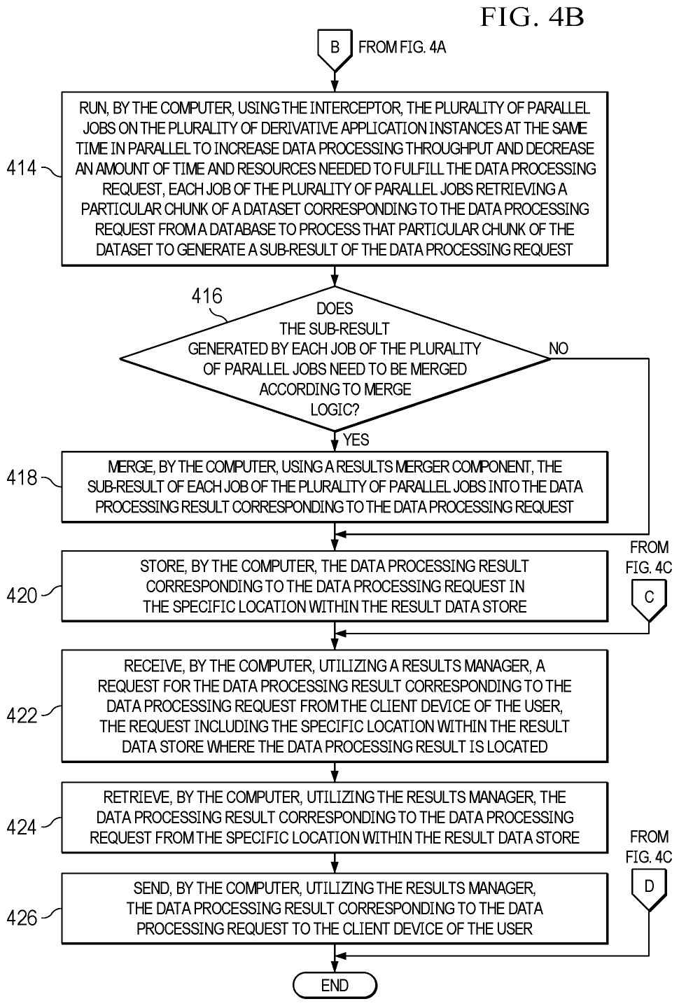

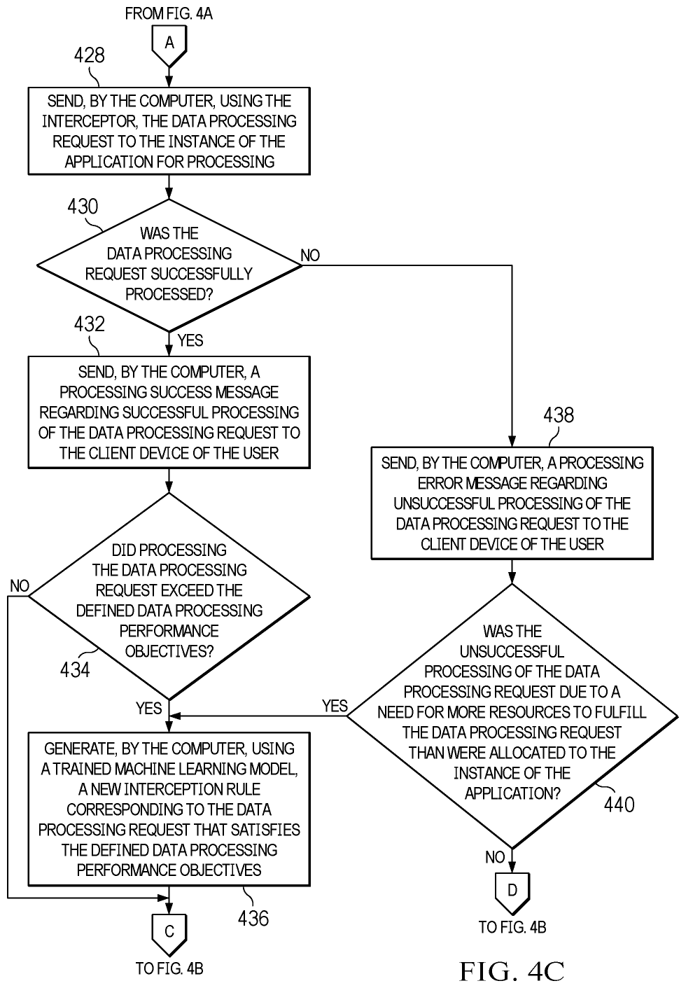

With reference now to FIGS. 4A-4C, a flowchart illustrating a process for . . . is shown in accordance with an illustrative embodiment. The process shown in FIGS. 4A-4C may be implemented in a computer, such as, for example, computer 101 in FIG. 1 or computer 202 in FIG. 2. For example, the process shown in FIGS. 4A-4C may be implemented by data processing enhancement code 200 in FIG. 1.

The process begins when the computer, using an interceptor, receives a data processing request corresponding to a service provided by an application of the computer from a client device of a user (step 402). In response to receiving the data processing request, the computer, using the interceptor, sends a response to the client device indicating acceptance of the data processing request and identification of a specific location within a result data store where a data processing result corresponding to the data processing request will be located (step 404). In addition, the computer, using the interceptor, makes a determination as to whether the data processing request satisfies an interception rule of a plurality of interception rules of the interceptor (step 406).

If the computer, using the interceptor, determines that the data processing request does satisfy an interception rule, then the computer, using the interceptor, divides the data processing request into a plurality of sub-requests in accordance with the interception rule to meet defined data processing performance objectives regarding at least one of time and resources needed to fulfill the data processing request (step 408). Further, the computer, using the interceptor, generates a plurality of parallel jobs to fulfill the data processing request in accordance with the defined data processing performance objectives (step 410). The interceptor generates one job for each respective sub-request of the plurality of sub-request.

Further, the computer, using the interceptor, generates a plurality of derivative application instances to run the plurality of parallel jobs based on an image of an instance of the application providing the service corresponding to the data processing request (step 412). The interceptor generates one derivative application instance for each respective job of the plurality of parallel jobs to run the plurality of parallel jobs at a same time in parallel to meet the defined data processing performance objectives. The computer, using the interceptor, runs the plurality of parallel jobs on the plurality of derivative application instances at the same time in parallel to increase data processing throughput and decrease an amount of time and resources needed to fulfill the data processing request (step 414). Each job of the plurality of parallel jobs retrieves a particular chunk of a dataset corresponding to the data processing request from a database to process that particular chunk of the dataset to generate a sub-result of the data processing request. Each job of the plurality of jobs sends a request to retrieve the dataset from the database with a corresponding derivative application instance intercepting the request to retrieve the dataset and modifying the request in accordance with the interception rule corresponding to the data processing request so that each job only retrieves and processes a specific chunk of the dataset.

Afterward, the computer, using a results merger component, makes a determination as to whether the sub-result generated by each job of the plurality of parallel jobs needs to be merged according to merge logic (step 416). If the computer, using the results merger component, determines that the sub-result generated by each job of the plurality of parallel jobs does not need to be merged according to the merge logic, no output of step 416, then the process proceeds to step 420. If the computer, using the results merger component, determines that the sub-result generated by each job of the plurality of parallel jobs does need to be merged according to the merge logic, yes output of step 416, then the computer, using a results merger component, merges the sub-result of each job of the plurality of parallel jobs into the data processing result corresponding to the data processing request (step 418). The computer stores the data processing result corresponding to the data processing request in the specific location within the result data store (step 420).

Subsequently, the computer, utilizing a results manager, receives a request for the data processing result corresponding to the data processing request from the client device of the user (step 422). The request includes the specific location within the result data store where the data processing result is located. In response to receiving the request, the computer, utilizing the results manager, retrieves the data processing result corresponding to the data processing request from the specific location within the result data store (step 424). Afterward, the computer, utilizing the results manager, sends the data processing result corresponding to the data processing request to the client device of the user (step 426). Thereafter, the process terminates.

Returning again to step 406, if the computer, using the interceptor, determines that the data processing request does not satisfy an interception rule, then the computer, using the interceptor, sends the data processing request to the instance of the application for processing (step 428). Subsequently, the computer determines whether the data processing request was successfully processed (step 430).

If the computer determines that the data processing request was successfully processed, yes output of step 430, then the computer sends a processing success message regarding successful processing of the data processing request to the client device of the user (step 432). In addition, the computer makes a determination as to whether processing the data processing request exceeded the defined data processing performance objectives (step 434).

If the computer determines that the processing of the data processing request did not exceed the defined data processing performance objectives, no output of step 434, then the process returns to step 422 where the computer subsequently receives a request for the data processing result. If the computer determines that the processing of the data processing request did exceed the defined data processing performance objectives, yes output of step 434, then the computer, using a trained machine learning model, generates a new interception rule corresponding to the data processing request that satisfies the defined data processing performance objectives (step 436). Thereafter, the process returns to step 422 where the computer subsequently receives a request for the data processing result.

Returning again to step 430, if the computer determines that the data processing request was not successfully processed, no output of step 430, then the computer sends a processing error message regarding unsuccessful processing of the data processing request to the client device of the user (step 438). Further, the computer makes a determination as to whether the unsuccessful processing of the data processing request was due to a need for more resources to fulfill the data processing request than were allocated to the instance of the application (step 440). If the computer determines that the unsuccessful processing of the data processing request was due to the need for more resources to fulfill the data processing request than were allocated to the instance of the application, yes output of step 440, then the process returns to step 436 where the computer, using the trained machine learning model, generates a new interception rule corresponding to the data processing request that satisfies the defined data processing performance objective. If the computer determines that the unsuccessful processing of the data processing request was not due to the need for more resources to fulfill the data processing request than were allocated to the instance of the application, no output of step 440, then the process terminates thereafter.

Thus, illustrative embodiments of the present disclosure provide a computer-implemented method, computer system, and computer program product for enhancing data processing by increasing throughput using a decreased amount of time and resources. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for enhancing data processing, the computer-implemented method comprising:
generating, by a computer, a plurality of derivative application instances to run a plurality of parallel jobs based on an image of an instance of an application providing a service corresponding to a data processing request, the computer generating one derivative application instance for each respective job of the plurality of parallel jobs to run the plurality of parallel jobs at a same time in parallel to meet defined data processing performance objectives; and
running, by the computer, the plurality of parallel jobs on the plurality of derivative application instances at the same time in parallel to increase data processing throughput and decrease an amount of time and resources needed to fulfill the data processing request, each job of the plurality of parallel jobs retrieves a particular chunk of a dataset corresponding to the data processing request from a database to process that particular chunk of the dataset to generate a sub-result of the data processing request.

2. The computer-implemented method of claim 1, further comprising:
receiving, by the computer, the data processing request corresponding to the service provided by the application of the computer from a client device of a user;
sending, by the computer, a response to the client device indicating acceptance of the data processing request and identification of a specific location where a data processing result corresponding to the data processing request will be located in response to receiving the data processing request; and
determining, by the computer, whether the data processing request satisfies an interception rule of a plurality of interception rules.

3. The computer-implemented method of claim 2, further comprising:
dividing, by the computer, the data processing request into a plurality of sub-requests in accordance with the interception rule to meet the defined data processing performance objectives regarding at least one of time and resources needed to fulfill the data processing request in response to the computer determining that the data processing request does satisfy the interception rule; and
generating, by the computer, the plurality of parallel jobs to fulfill the data processing request in accordance with the defined data processing performance objectives, the computer generating one job for each respective sub-request of the plurality of sub-request.

4. The computer-implemented method of claim 2, further comprising:
sending, by the computer, the data processing request to the instance of the application for processing in response to the computer determining that the data processing request does not satisfy the interception rule; and
determining, by the computer, whether the data processing request was successfully processed.

5. The computer-implemented method of claim 4, further comprising:
sending, by the computer, a processing success message regarding successful processing of the data processing request to the client device of the user in response to the computer determining that the data processing request was successfully processed;
determining, by the computer, whether processing the data processing request exceeded the defined data processing performance objectives; and
generating, by the computer, a new interception rule corresponding to the data processing request that satisfies the defined data processing performance objectives in response to the computer determining that the processing of the data processing request did exceed the defined data processing performance objectives.

6. The computer-implemented method of claim 4, further comprising:
sending, by the computer, a processing error message regarding unsuccessful processing of the data processing request to the client device of the user in response to the computer determining that the data processing request was not successfully processed;
determining, by the computer, whether the unsuccessful processing of the data processing request was due to a need for more resources to fulfill the data processing request than were allocated to the instance of the application; and
generating, by the computer, a new interception rule corresponding to the data processing request that satisfies the defined data processing performance objective in response to the computer determining that the unsuccessful processing of the data processing request was due to the need for more resources to fulfill the data processing request than were allocated to the instance of the application.

7. The computer-implemented method of claim 1, further comprising:
determining, by the computer, whether the sub-result generated by each job of the plurality of parallel jobs needs to be merged according to merge logic;
merging, by the computer, the sub-result of each job of the plurality of parallel jobs into a data processing result corresponding to the data processing request in response to the computer determining that the sub-result generated by each job of the plurality of parallel jobs needs to be merged according to the merge logic; and
storing, by the computer, the data processing result corresponding to the data processing request in a specific location.

8. The computer-implemented method of claim 1, further comprising:
receiving, by the computer, a request for a data processing result corresponding to the data processing request from a client device of a user, the request including a specific location where the data processing result is located;
retrieving, by the computer, the data processing result corresponding to the data processing request from the specific location; and
sending, by the computer, the data processing result corresponding to the data processing request to the client device of the user.

9. A computer system for enhancing data processing, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
generate a plurality of derivative application instances to run a plurality of parallel jobs based on an image of an instance of an application providing a service corresponding to a data processing request, wherein one derivative application instance is generated for each respective job of the plurality of parallel jobs to run the plurality of parallel jobs at a same time in parallel to meet defined data processing performance objectives; and
run the plurality of parallel jobs on the plurality of derivative application instances at the same time in parallel to increase data processing throughput and decrease an amount of time and resources needed to fulfill the data processing request, each job of the plurality of parallel jobs retrieves a particular chunk of a dataset corresponding to the data processing request from a database to process that particular chunk of the dataset to generate a sub-result of the data processing request.

10. The computer system of claim 9, wherein the set of processors further executes the program instructions to:
receive the data processing request corresponding to the service provided by the application from a client device of a user;
send a response to the client device indicating acceptance of the data processing request and identification of a specific location where a data processing result corresponding to the data processing request will be located in response to receiving the data processing request; and
determine whether the data processing request satisfies an interception rule of a plurality of interception rules.

11. The computer system of claim 10, wherein the set of processors further executes the program instructions to:
divide the data processing request into a plurality of sub-requests in accordance with the interception rule to meet the defined data processing performance objectives regarding at least one of time and resources needed to fulfill the data processing request in response to determining that the data processing request does satisfy the interception rule; and
generate the plurality of parallel jobs to fulfill the data processing request in accordance with the defined data processing performance objectives, wherein one job is generated for each respective sub-request of the plurality of sub-request.

12. The computer system of claim 10, wherein the set of processors further executes the program instructions to:
send the data processing request to the instance of the application for processing in response to determining that the data processing request does not satisfy the interception rule; and
determine whether the data processing request was successfully processed.

13. The computer system of claim 12, wherein the set of processors further executes the program instructions to:
send a processing success message regarding successful processing of the data processing request to the client device of the user in response to determining that the data processing request was successfully processed;
determine whether processing the data processing request exceeded the defined data processing performance objectives; and
generate a new interception rule corresponding to the data processing request that satisfies the defined data processing performance objectives in response to determining that the processing of the data processing request did exceed the defined data processing performance objectives.

14. The computer system of claim 12, wherein the set of processors further executes the program instructions to:
send a processing error message regarding unsuccessful processing of the data processing request to the client device of the user in response to determining that the data processing request was not successfully processed;
determine whether the unsuccessful processing of the data processing request was due to a need for more resources to fulfill the data processing request than were allocated to the instance of the application; and
generate a new interception rule corresponding to the data processing request that satisfies the defined data processing performance objective in response to determining that the unsuccessful processing of the data processing request was due to the need for more resources to fulfill the data processing request than were allocated to the instance of the application.

15. A computer program product for enhancing data processing, the computer program product comprising a set of computer-readable storage media having program instructions collectively stored therein, the program instructions executable by a computer to cause the computer to:
generate a plurality of derivative application instances to run a plurality of parallel jobs based on an image of an instance of an application providing a service corresponding to a data processing request, the computer generating one derivative application instance for each respective job of the plurality of parallel jobs to run the plurality of parallel jobs at a same time in parallel to meet defined data processing performance objectives; and
run the plurality of parallel jobs on the plurality of derivative application instances at the same time in parallel to increase data processing throughput and decrease an amount of time and resources needed to fulfill the data processing request, each job of the plurality of parallel jobs retrieves a particular chunk of a dataset corresponding to the data processing request from a database to process that particular chunk of the dataset to generate a sub-result of the data processing request.

16. The computer program product of claim 15, wherein the program instructions further cause the computer to:
receive the data processing request corresponding to the service provided by the application of the computer from a client device of a user;
send a response to the client device indicating acceptance of the data processing request and identification of a specific location where a data processing result corresponding to the data processing request will be located in response to receiving the data processing request; and
determine whether the data processing request satisfies an interception rule of a plurality of interception rules.

17. The computer program product of claim 16, wherein the program instructions further cause the computer to:
divide the data processing request into a plurality of sub-requests in accordance with the interception rule to meet the defined data processing performance objectives regarding at least one of time and resources needed to fulfill the data processing request in response to determining that the data processing request does satisfy the interception rule; and
generate the plurality of parallel jobs to fulfill the data processing request in accordance with the defined data processing performance objectives, the computer generating one job for each respective sub-request of the plurality of sub-request.

18. The computer program product of claim 16, wherein the program instructions further cause the computer to:
send the data processing request to the instance of the application for processing in response to determining that the data processing request does not satisfy the interception rule; and
determine whether the data processing request was successfully processed.

19. The computer program product of claim 18, wherein the program instructions further cause the computer to:
send a processing success message regarding successful processing of the data processing request to the client device of the user in response to determining that the data processing request was successfully processed;
determine whether processing the data processing request exceeded the defined data processing performance objectives; and
generate a new interception rule corresponding to the data processing request that satisfies the defined data processing performance objectives in response to determining that the processing of the data processing request did exceed the defined data processing performance objectives.

20. The computer program product of claim 18, wherein the program instructions further cause the computer to:
send a processing error message regarding unsuccessful processing of the data processing request to the client device of the user in response to determining that the data processing request was not successfully processed;
determine whether the unsuccessful processing of the data processing request was due to a need for more resources to fulfill the data processing request than were allocated to the instance of the application; and
generate a new interception rule corresponding to the data processing request that satisfies the defined data processing performance objective in response to determining that the unsuccessful processing of the data processing request was due to the need for more resources to fulfill the data processing request than were allocated to the instance of the application.
